(19) United States
(12) Patent Application Publication
(10) Pub. No.: US 2026/0188986 A1
(43) Pub. Date: Jul. 2, 2026

(54) DUCTLESS MEDIUM VOLTAGE (MV) SWITCHGEAR WITH HORIZONTAL MULTILAYER ARC ABSORBER WITH OBTUSE EXHAUST CHIMNEY DESIGN

(71) Applicant: Eaton Intelligent Power Limited, Dublin 4 (IE)

(72) Inventors: Nikhil Pingale, Pune (IN); Ajay Gulig, Pune (IN); Ravindra Rikame, Pune (IN); Lalit Patil, Greenwood, SC (US); Jared Hines, Greenwood, SC (US)

(21) Appl. No.: 19/004,589

(22) Filed: Dec. 30, 2024

(51) Int. Cl. H02B 13/025; H01H 9/34; H01H 9/36

(52) U.S. Cl. CPC H02B 13/025; H01H 9/342; H01H 9/345; H01H 9/362

(57) ABSTRACT

An arc absorber is provided for diffusing an arc fault of a switchgear. The arc absorber includes an arc absorber housing having an opening therein at a first end of the housing, the opening receiving gases generated inside the switchgear; a rear plate at the first end of the housing, the rear plate angled or square to divert the gases towards a middle portion of the housing; one or more absorbers that cool the gases diverted from the rear plate as the gas travels through the one or more absorbers; a front plate at a second end of the housing, opposite the first end of the housing, the front plate angled or square to divert the cooled gases to an upper portion of the arc absorber; and a chimney at the upper portion of the arc absorber at the second end of the housing, the chimney receiving the cooled gases diverted from the front plate and dispersing the cooled gases outside the arc absorber housing towards the first end of the housing away from an operator of the switchgear through an opening in the chimney.

### FIELD

The present inventive concept relates generally to medium voltage (MV) switchgear and, more particularly, to duct arrangements for a MV switchgear to diffuse an arc fault.

### BACKGROUND

Medium voltage (MV) switchgear is a collection of circuit protection devices that control and distribute power in alternating current (AC) systems. MV switchgear is used in many sectors, including industrial, commercial, and utility installations, as well as in power generation, distribution centers, and renewable energy plants.

An arc fault is a dangerous electrical event that occurs when an unintended electrical arc or spark discharges between two or more conductors. Arc faults in MV switchgear can be caused by a number of factors, including, for example: equipment failure: insulation breakdown, defective contact points, or incorrect rating or dimensioning can all lead to arc faults; maintenance and installation: negligence during maintenance or installation can cause arc faults; foreign objects: dropping tools or other foreign objects into the equipment can cause short circuits and arcs; corrosion: corrosion of equipment parts can weaken contact between conductor terminals, leading to arcing faults; over voltage: over voltage across narrow gaps can ionize the air, producing arc faults; and improper maintenance: improper maintenance procedures can lead to arc faults

Arc faults in MV switchgear can pose a high fire risk and be dangerous for people and equipment. Arc-flash explosions can release toxic fumes, thermal heat, sound waves, and pressure. To mitigate arc flash hazards, switchgear panels can be equipped with arc fault protection systems. These systems can detect arc flashes and send trip commands to circuit breakers to protect people and reduce damage. Arc-resistant equipment can also be used to safely contain and redirect arc energy.

Conventional designs for internal arc faults may include arc ducts. These arc ducts may extend from the side/back of the switchgear. The ducts vary in length from relatively short to relatively long. These ducts may be supported by a support column and installed in, for example, a multiple section assembly. In the event of an arc, the ducts carry the hot gases generated inside the switchgear by the arc to a location outside of a switchgear room into an open area away from the operator where the hot gases can dissipate.

These arc ducts generally require customers to build the duct assembly at the customer site due to a high number of joints along the length of the duct and the customer must generally build the support structure according to particular guidelines. Finally, the customer must have a dedicated space for placement of the arc ducts and build an opening for the gas to pass through and away from the switchgear. Accordingly, improved methods of dealing with arc faults using arc ducts are desired.

### SUMMARY

Some embodiments of the present inventive concept provide an arc absorber for diffusing an arc fault of a switchgear. The arc absorber includes an arc absorber housing having an opening therein at a first end of the housing, the opening receiving gases generated inside the switchgear; a rear plate at the first end of the housing, the rear plate angled or square to divert the gases towards a middle portion of the housing; one or more absorbers that cool the gases diverted from the rear plate as the gas travels through the one or more absorbers; a front plate at a second end of the housing, opposite the first end of the housing, the front plate angled or square to divert the cooled gases to an upper portion of the arc absorber; and a chimney at the upper portion of the arc absorber at the second end of the housing, the chimney receiving the cooled gases diverted from the front plate and dispersing the cooled gases outside the arc absorber housing towards the first end of the housing away from an operator of the switchgear through an opening in the chimney.

In some embodiments, the one or more absorbers may be a total of nine (9) absorbers. The nine absorbers may be configured in a 3 by 3 matrix towards a center of the housing.

In further embodiments, the one or more absorbers may be positioned in an absorber housing inside the arc absorber housing.

In still further embodiments, the chimney may further include a thin metal sheet on an opening thereof. The thin metal sheet may have a flap or perforation therein. The flap or perforation allows the gases diverted to the chimney to be expelled from the arc absorber housing.

In some embodiments, the opening of the chimney may be inclined to force the expelled gases to a rear end of the switchgear away from the operator of the switchgear. The chimney surface including the opening may be inclined about 125 degrees.

In further embodiments, the rear plate may be inclined and positioned at the first end of the arc absorber housing in an upper corner of the arc absorber housing.

In still further embodiments, the front plate may be inclined and positioned in a lower corner at the second end of the housing.

Some embodiments of the present inventive concept provide a switchgear having a ductless switchgear panel having an arc absorber for diffusing an arc fault. The arc absorber includes an arc absorber housing having an opening therein at a first end of the housing, the opening receiving gases generated inside the switchgear; a rear plate at the first end of the housing, the rear plate angled to divert the gases towards a middle portion of the housing; one or more absorbers that cool the gases diverted from the rear plate as the gas travels through the one or more absorbers; a front plate at a second end of the housing, opposite the first end of the housing, the front plate angled to divert the cooled gases to an upper portion of the arc absorber; and a chimney at the upper portion of the arc absorber at the second end of the housing, the chimney receiving the cooled gases diverted from the front plate and dispersing the cooled gases outside the arc absorber housing towards the first end of the housing away from an operator of the switchgear through an opening in the chimney.

In further embodiments, the switchgear may include two or more arc absorbers boxes positioned on a top surface thereof.

In still further embodiments, the switchgear may include three arc absorbers boxes positioned on a top surface thereof.

### BRIEF DESCRIPTION OF THE DRAWINGS

FIG. 1 is a diagram illustrating a conventional switchgear having an arc duct associated therewith.

FIGS. 2A through 2C are graphs illustrating simulation results associated with the system of FIG. 1.

FIG. 3 is a diagram illustrating a switchgear including a ductless arc absorber in accordance with some embodiments of the present inventive concept.

FIGS. 4A and 4B are diagrams illustrating a perspective view and a bottom perspective view of a single unit of the absorber in accordance with some embodiments of the present inventive concept.

FIG. 5 is a diagram illustrating an arc absorber in accordance with some embodiments of the present inventive concept.

FIG. 6 is a diagram illustrating a system including arc absorbers in accordance with some embodiments of the present inventive concept.

FIGS. 7A through 7C are graphs comparing duct versus ductless systems in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

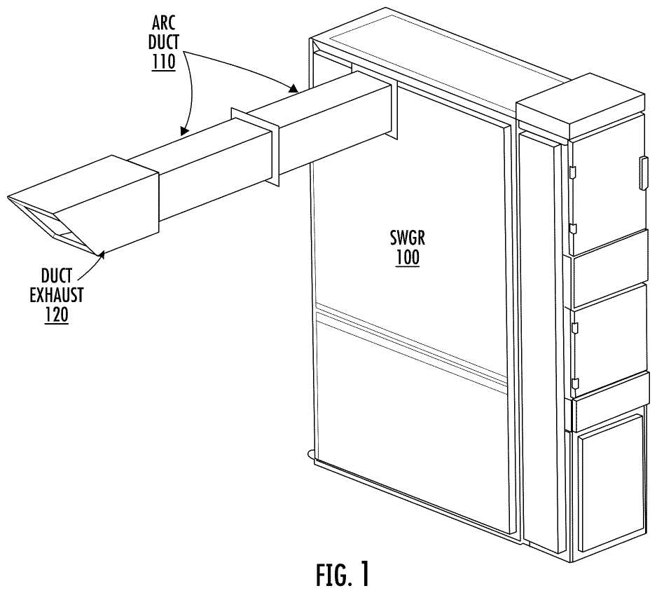

A conventional duct system is illustrated, for example, in FIG. 1. The system of FIG. 1 includes a switchgear 100, an arc duct 110 and a duct exhaust 120. As illustrated, the arc duct 110 extends from a side panel of the switchgear 100, which can vary in length, e.g., several meters. This arc duct 110 carries hot gases from the switchgear enclosure 100 outside the room generated during internal arc fault. It will be understood that the system illustrated in FIG. 1 are provided for example only and that embodiments of the present inventive concept are not limited to this configuration.

As illustrated, the space present below the duct exhaust 120 is generally underutilized because of the need for a restricted space for arc exhaust. The addition of a support for the arc duct 110 illustrated in FIG. 1 may also require support from below that limits use of space. Further, arc duct typically requires an opening in the wall of the room to carry the arc exhaust outside of the switchgear/electrical room. Thus, if the switchgear 100 is placed in a remote location at the customer site and does not have proximity to the outside open area, venting the arc exhaust can be difficult and costly. In some locations, the duct is run over a large distance, which further increases complexity and cost.

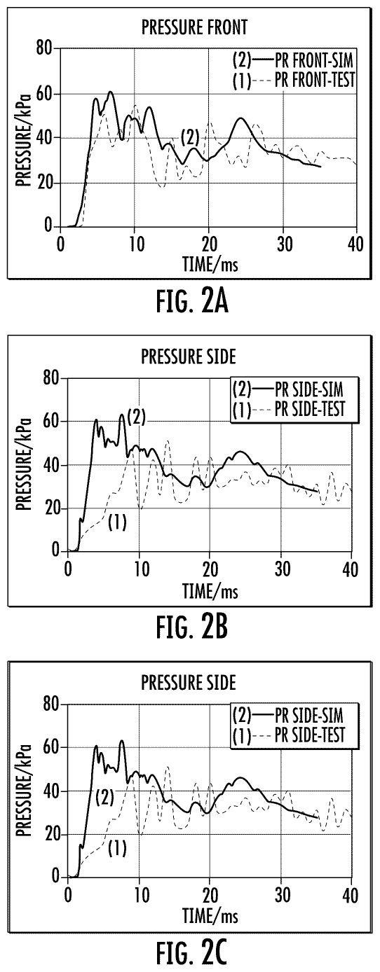

FIGS. 2A through 2C are graphs illustrating front pressure, side pressure and exhaust pressure, respectively, in conventional systems. As illustrated, the graphs show pressure (kPa) versus time (ms). A test was performed with a supply panel and test panel with the duct on the side. The results in FIGS. 2A through 2C compare pressure generated in panel in actual testing (1) and simulation (2) in respective sections of the switchgear 100. The peak pressure generated was 64 kPa on a side of the panel and −68 kPa at exit of duct.

Accordingly, some embodiments of the present inventive concept provide a ductless arc absorber. The ductless arc absorber in accordance with embodiments discussed herein eliminates the need for an arc duct 110, which results in space savings, eliminates a need for a wall pass-through and other duct related work at customer site as will be discussed below.

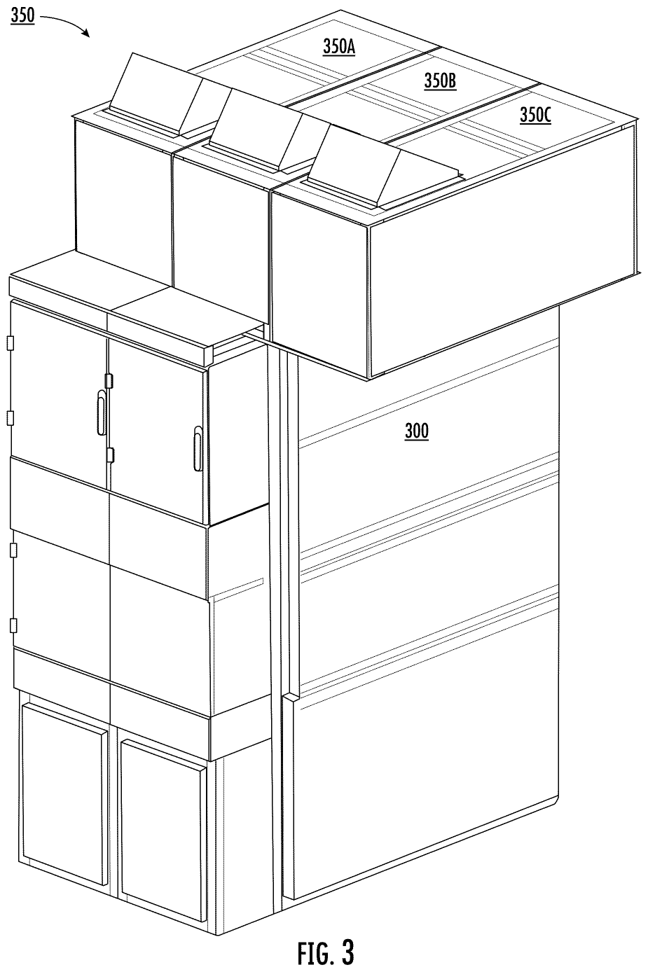

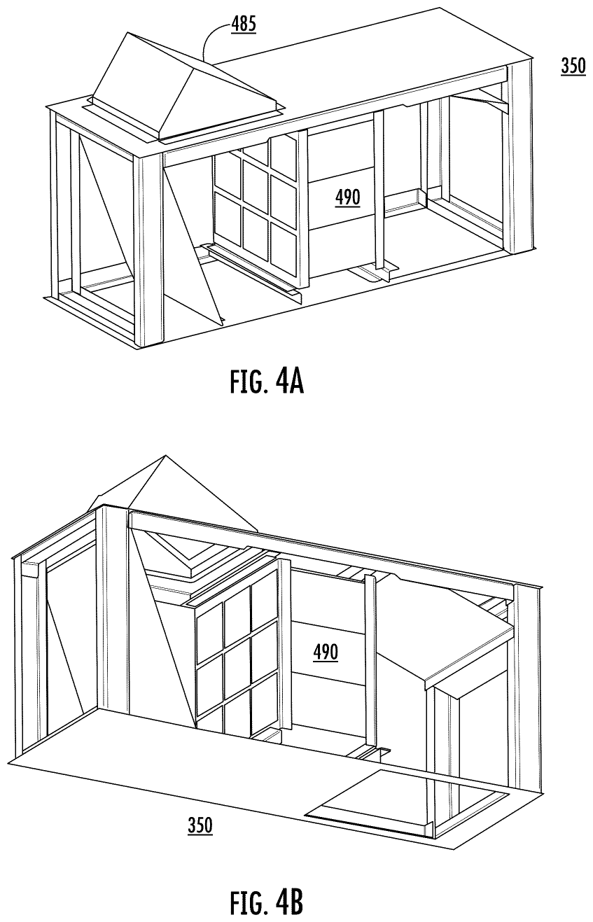

Referring now to FIG. 3, a switchgear 300 including an arc absorber 350 including arc absorbers 350 (used to reference any of arc absorbers 350A, 350B or 350C or all three) in accordance with some embodiments of the present inventive concept will be discussed. It will be understood that the system illustrated in FIG. 3 is an example only and embodiments are not limited thereto. FIG. 3 illustrates an example arc absorber 350 having three (3) units (A, B, C) on top surface of the switchgear 300. These arc absorbers 350 are each enclosed in a housing/arc absorber box (modular assembly), which may reduce installation time at the customer site. FIGS. 4A and 4B illustrate a perspective view and a bottom perspective view of a single unit of the absorber 350 in accordance with embodiments discussed herein.

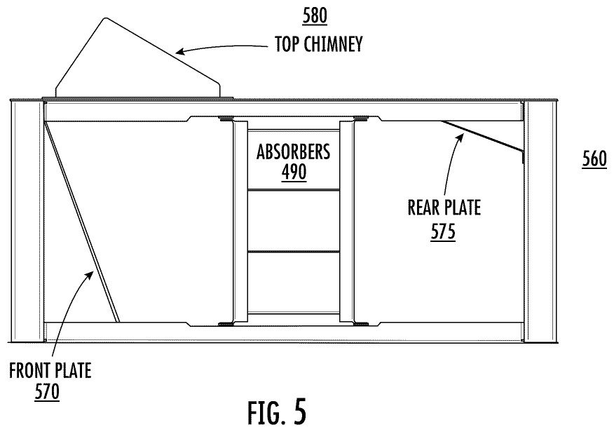

As illustrated in FIG. 3, in some embodiments, the system includes three arc absorbers 350 (A-C). These arc absorbers 350 are positioned on a top surface of the switchgear 300. The arc absorbers are positioned with a first end at the rear end of the switchgear 300 and a second end, opposite the first end, at a front portion of the switchgear 300. FIG. 5 is a diagram illustrating a cross-section of an arc absorber 350 (1 of 3 in FIG. 3) in accordance with some embodiments of the present inventive concept.

As illustrated in FIG. 5, the arc absorbers include an arc absorber housing 560. Within the housing 560, a metal sheet is placed at one end (front) (front plate 570) and at a second/rear end (rear plate 575) of the arc absorber housing 560 in a square or an inclined manner as shown. A chimney 580 is installed at the top of arc absorber housing 560. A flap (not shown) is fixed with perforations at one end on the chimney exit. Gases may be expelled to atmosphere through the chimney 580. The actual absorbers 490 are placed in the housing 560 in the center. In embodiments illustrated herein, there are nine total absorbers placed in a 3×3 configuration—as illustrated in FIG. 4B. It will be understood that the 3×3 configurations is provided as an example only and more or less than nine (9) absorbers can be included without departing from the scope of the present inventive concept.

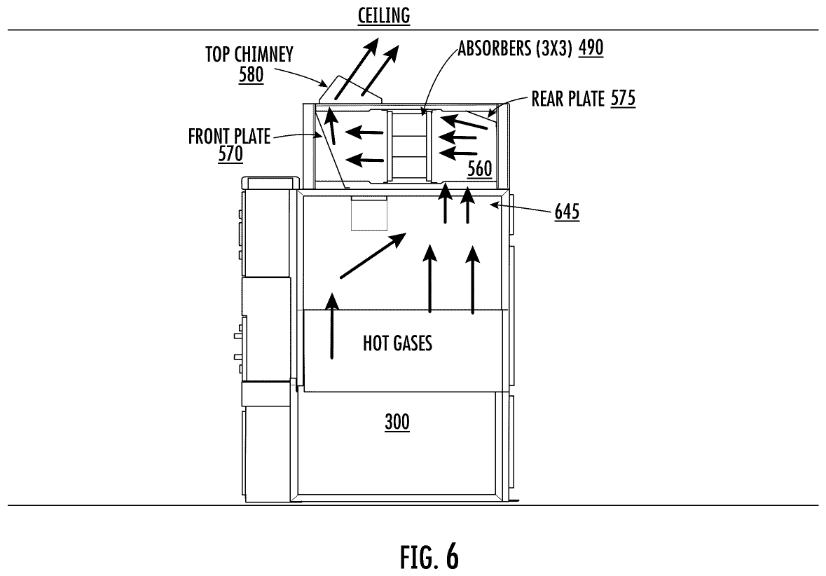

Switchgear 300 including arc absorbers 350 (used to reference any of arc absorbers 350A, 350B or 350C or all three) in accordance with embodiments discussed herein will be further discussed with respect to FIG. 6. In some embodiments, the switchgear 300 is installed with three absorber box assemblies 350 (referring to A, B and C of FIG. 3) on top thereof. In these embodiments, each absorber box contains a 3×3 matrix totaling 9 absorbers. Thus, all three absorber boxes include a total of 27 absorbers for each panel. It will be understood that other configurations may be contemplated without deviating from the scope of the present inventive concept. For example, if only one layer of absorbers were provided per box, 9 boxes would be required to provide a minimum numbers of absorbers needed for each panel.

Embodiments illustrated in FIG. 6 include 3 layers of 3 (9 total) per absorber box assembly and, thus, achieve the minimum number of absorbers (27) with only 3 box 260 assemblies on top of the switchgear 300. In some embodiments, the arc absorbers are arranged in parallel to increase cross section at inlet of gases as much as possible to reduce pressure build-up inside the panel (back pressure).

As illustrated in FIG. 6, arc gases (hot gases) generated in the switchgear 300 enter in absorber housing 560 from an opening 545 at the rear side (first end) of switchgear 300 as illustrated by the arrows extending into the housing 560 at the rear. These hot gases are directed to the front side (second end) of the housing 560 by a rear plate 575 that is inclined or square in an upper corner of the housing 560. As shown, these hot gases pass through the absorbers 490, which will cool the gases. These cooled gases hit a front plate 570 that is inclined or square in the lower corner at the front end of the housing 560 and get directed to the top chimney 580.

Chimney 580 is installed with thin metal sheet (485—FIG. 4A) at its opening which has a flap or is perforated at one end to allow the gas to escape. In some embodiments, the chimney 580 is inclined about 125 degrees to direct the escaping gas towards the back side of the switchgear so hot gases do not fall towards the front of the switchgear 300 where the operator may be located. This reduces risks to the operator. The angle is not limited to 125 degrees, the angle must be enough to direct the gases away from the front of the switchgear.

In operation, using an inclined chimney will force the hot gases to hit the ceiling first and then fall mostly on top of the switchgear and not on the operator standing in front. A small portion of gases, directed from ceiling on to the floor side will get sufficient time to cool down and burn risk to the operator may be reduced or possibly eliminated.

The flap/perforation in thin metal sheet 485 on the chimney 580 discussed above allows thin metal sheet 485 to bend back and provide the opening for gases to escape. The purpose of this thin sheet 485 is to provide protection against any foreign material dropping from above the unit and entering the switchgear. In other words, the thin metal sheet prevents debris from getting into the switchgear. It will be understood that although the thin sheet 485 is discussed as being metal, other suitable materials may be used without departing from the scope of the present inventive concept.

As discussed above, the arc boxes/housing may be modular in style, thus, they can be assembled relatively easily at the customer site. They are configured to fit together quickly without too much assembly required.

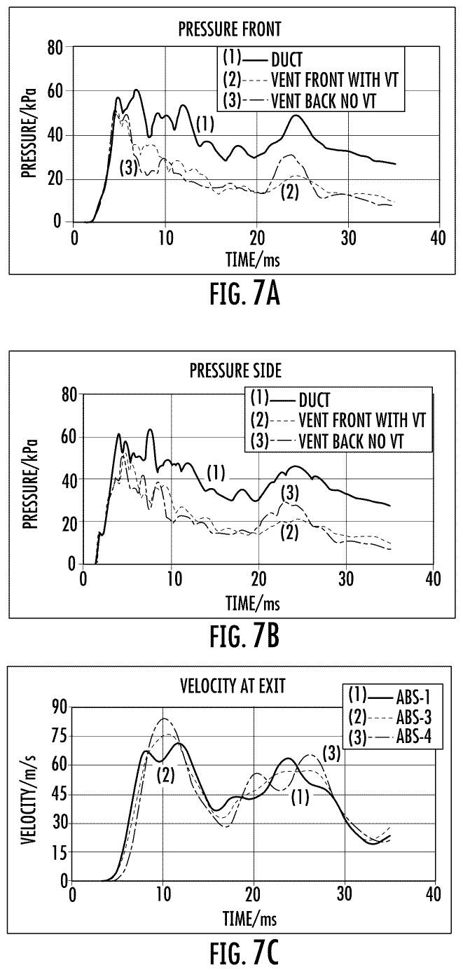

Referring now to FIGS. 7A through 7C, simulation results for switchgear including ductless arc absorbers in accordance with some embodiments of the present inventive concept will be discussed. As illustrated, the graphs show pressure (kPa) versus time (ms) (A and B) and velocity (m/s) versus time (ms) (C). The results in FIGS. 7A through 7C compare pressure generated in panel with the duct and ductless configurations. The peak pressure generated was 50 kPa on a side of the front and side panel. In FIG. 7A and &B, line (1) is the duct, (2) vent front with VT and (3) Vent back no VT. In FIG. 7C, line (1) is absorber A, line (2) is absorber B and line (3) is absorber C.

As briefly discussed above, some embodiments of the present inventive concept provide switchgear including a ductless absorber so that the switchgear does not have to be vented using long ducts to an exterior location. Furthermore, the arc absorbers can act as a filter for large and heavy molten particles and reduce the velocity and pressure of arc gases coming out of the switchgear. Embodiments discussed herein simplify the installation of the switchgear and provide flexibility as to location of the switchgear at the customer site.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

What is claimed is:

1. An arc absorber for diffusing an arc fault of a switchgear, the arc absorber comprising:
an arc absorber housing having an opening therein at a first end of the housing, the opening receiving gases generated inside the switchgear;
a rear plate at the first end of the housing, the rear plate angled or square, to divert the gases towards a middle portion of the housing;
one or more absorbers that cool the gases diverted from the rear plate as the gas travels through the one or more absorbers;
a front plate at a second end of the housing, opposite the first end of the housing, the front plate angled or square to divert the cooled gases to an upper portion of the arc absorber; and
a chimney at the upper portion of the arc absorber at the second end of the housing, the chimney receiving the cooled gases diverted from the front plate and dispersing the cooled gases outside the arc absorber housing towards the first end of the housing away from an operator of the switchgear through an opening in the chimney.

2. The arc absorber of claim 1, wherein the one or more absorbers comprise a total of nine (9) absorbers.

3. The arc absorber of claim 2, wherein the nine absorbers are configured in a 3 by 3 matrix towards a center of the housing.

4. The arc absorber of claim 1, wherein the one or more absorbers are positioned in an absorber housing inside the arc absorber housing.

5. The arc absorber of claim 1, wherein the chimney further comprises a thin metal sheet on an opening thereof, the thin metal sheet having a flap or perforation therein, the flap or perforation allowing the gases diverted to the chimney to be expelled from the arc absorber housing.

6. The arc absorber of claim 5, wherein the opening of the chimney is inclined to force the expelled gases to a rear end of the switchgear away from the operator of the switchgear.

7. The arc absorber of claim 6, wherein the chimney surface including the opening is inclined about 125 degrees.

8. The arc absorber of claim 1, wherein the rear plate is inclined or square and positioned at the first end of the arc absorber housing in an upper corner of the arc absorber housing.

9. The arc absorber of claim 1, wherein the front plate is inclined or square and is positioned in a lower corner at the second end of the housing.

10. A switchgear having a ductless arc absorber for diffusing an arc fault, wherein the arc absorber comprises:
an arc absorber housing having an opening therein at a first end of the housing, the opening receiving gases generated inside the switchgear;
a rear plate at the first end of the housing, the rear plate angled or square, to divert the gases towards a middle portion of the housing;
one or more absorbers that cool the gases diverted from the rear plate as the gas travels through the one or more absorbers;
a front plate at a second end of the housing, opposite the first end of the housing, the front plate angled or square to divert the cooled gases to an upper portion of the arc absorber; and
a chimney at the upper portion of the arc absorber at the second end of the housing, the chimney receiving the cooled gases diverted from the front plate and dispersing the cooled gases outside the arc absorber housing towards the first end of the housing away from an operator of the switchgear through an opening in the chimney.

11. The switchgear of claim 10, wherein the switchgear comprises two or more arc absorbers positioned on a top surface thereof.

12. The switchgear of claim 11, wherein the switchgear comprises three arc absorbers positioned on a top surface thereof.

13. The switchgear of claim 10, wherein the one or more absorbers comprise a total of nine (9) absorbers.

14. The switchgear of claim 13, wherein the nine absorbers are configured in a 3 by 3 matrix towards a center of the housing.

15. The switchgear of claim 10, wherein the one or more absorbers are positioned in an absorber housing inside the arc absorber housing.

16. The switchgear of claim 10, wherein the chimney further comprises a thin metal on an opening thereof, the thin metal sheet having a flap or perforation therein, the flap or perforation allowing the gases diverted to the chimney to be expelled from the arc absorber housing.

17. The switchgear of claim 16, wherein the opening of the chimney is inclined to force the expelled gases to a rear end of the switchgear away from the operator of the switchgear.

18. The arc absorber of claim 17, wherein the chimney surface including the opening is inclined about 125 degrees.

19. The switchgear of claim 10, wherein the rear plate is inclined or square and positioned at the first end of the arc absorber housing in an upper corner of the arc absorber housing.

20. The switchgear of claim 10, wherein the front plate is inclined or square and is positioned in a lower corner at the second end of the housing.
